(19) United States
(12) Patent Application Publication
(10) Pub. No.: US 2012/0331125 A1
(43) Pub. Date: Dec. 27, 2012

(54) Resource Use Management System

(75) Inventors: Tong Li, Cary, NC (US); Yongcheng Li, Cary, NC (US); Yuping C. Wu, Cary, NC (US); Chunshan A. Zhang, Cary, NC (US)

(73) Assignee: INTERNATIONAL BUSINESS MACHINES CORPORATION, Armonk, NY (US)

(21) Appl. No.: 13/166,414

(22) Filed: Jun. 22, 2011

(51) Int. Cl. G06F 15/173

(52) U.S. Cl. 709/224

(57) ABSTRACT

A method and apparatus for managing resources is provided. Responsive to a request for a set of resources by a user, a token is added to a response to the request generated by a server application. The requests are monitored from the user. The token identifies the user. A pattern of use by the user is identified. A determination is made as to whether overuse of the set of resources has occurred based on the pattern of use and a policy.

### BACKGROUND

1. Field

The present disclosure relates generally to an improved data processing system and, in particular, to a method and apparatus for managing resources. Still more particularly, the present disclosure relates to a method and apparatus for managing resources requested by a user.

2. Description of the Related Art

The Internet is a global system of interconnected computer networks. These networks may include private, public, academic, business, government, and/or other types of networks. These different networks are connected to each other by different wired, wireless, and/or optical networking technologies. The Internet provides a large amount of information. These resources may include information databases, services, and/or other types of resources. In addition to being used as a source of information, the Internet also is used as a medium for business activities.

Many businesses, government entities, and other organizations have a presence on the Internet. Websites are used to perform various transactions, as well as provide information. Also, these and other organizations may offer goods and services for sale to customers.

Further, the Internet also provides users access to resources to perform different tasks. More specifically, users may access applications on the Internet. This type of access may be provided through cloud computing. For example, a user may use an email application to send and receive messages. The email application is located in the cloud rather than at the user's computer. As another example, a user may access a database using a database application located in the cloud. The applications used to perform these tasks are not located on the user's computer. The user may access these and other applications from any computer.

Users of cloud computing systems do not own the physical structure. Instead, the users pay for resources that they use. Cloud computing provides the resources to the user as if the resources are physically located with the user. As a result, a user can access a resource that may be located almost anywhere in the world.

### SUMMARY

In one illustrative embodiment, a method for managing resources is provided. Responsive to a request for a set of resources by a user, a token is added to a response to the request generated by a server application. The requests are monitored from the user. The token identifies the user. A pattern of use by the user is identified. A determination is made as to whether overuse of the set of resources has occurred based on the pattern of use and a policy.

In another illustrative embodiment, a computer system comprises a bus, a set of storage devices, and a processor unit. The set of storage devices is connected to the bus. The program code is stored on the set of storage devices. The processor unit is configured to run the program code to add a token to a response to a request for a set of resources generated by a server application in response to the request for the set of resources by a user. The processor unit is further configured to monitor requests from the user. The token identifies the user. The processor unit is further configured to identify a pattern of use by the user. The processor unit is further configured to determine whether overuse of the set of resources has occurred based on the pattern of use and a policy.

In yet another illustrative embodiment, a computer program product comprises a computer readable storage medium, first program code, second program code, third program code, and fourth program code. The first program code, responsive to a request for a set of resources by a user, is for adding a token to a response to the request generated by a server application. The second program code is for monitoring requests from the user. The token identifies the user. The third program code is for identifying a pattern of use by the user. The fourth program code is for determining whether overuse of the set of resources has occurred based on the pattern of use and a policy. The first program code, the second program code, the third program code, and the fourth program code are stored on the computer readable storage medium.

### BRIEF DESCRIPTION OF THE SEVERAL VIEWS OF THE DRAWINGS

FIG. 1 is an illustration of a block diagram of a cloud computing node in accordance with an illustrative embodiment;

FIG. 2 is an illustration of a cloud computing environment in accordance with an illustrative embodiment;

FIG. 3 is an illustration of model layers in accordance with an illustrative embodiment;

FIG. 4 is an illustration of a resource management environment in accordance with an illustrative embodiment;

FIG. 5 is an illustration of a flowchart of a process for managing resources in accordance with an illustrative embodiment;

FIG. 6 is an illustration of a flowchart of a process for determining whether overuse of a set of resources has occurred based on a pattern of use in accordance with an illustrative embodiment; and

FIG. 7 is an illustration of a flowchart of a process for managing a policy in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language, such as Java, Smalltalk, C++, or the like and conventional procedural programming languages, such as the “C” programming language or similar programming languages. The program code may run entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowcharts and/or block diagrams of methods, apparatuses (systems), and computer program products according to embodiments of the invention. It will be understood that each block of the flowcharts and/or block diagrams, and combinations of blocks in the flowcharts and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It is understood in advance that although this disclosure includes a detailed description on cloud computing, implementation of the teachings recited herein are not limited to a cloud computing environment. Rather, the illustrative embodiments are capable of being implemented in conjunction with any other type of computing environment now known or later developed.

For convenience, the disclosure includes the following definitions which have been derived from the “Draft NIST Working Definition of Cloud Computing” by Peter Mell and Tim Grance, dated Oct. 7, 2009, which is cited in an information disclosure statement filed herewith.

Cloud computing is a model of service delivery for enabling convenient, on-demand network access to a shared pool of configurable computing that can be rapidly provisioned and released with minimal management effort or interaction with a provider of the service. The computer resources may be, for example, resource networks, network bandwidth, servers, processing, memory, storage, applications, virtual machines, and services. This cloud model may include at least five characteristics, at least three service models, and at least four deployment models.

Characteristics include on-demand self-service, broad network access, resource pooling, rapid elasticity, and measured service. With on-demand self-service: a cloud consumer can unilaterally provision computing capabilities as needed automatically without requiring human interaction with the service's provider. The computer capabilities include, for example, server time and network storage.

Broad network access involves capabilities that are available over a network and accessed through standard mechanisms that promote use by heterogeneous thin or thick client platforms, such as mobile phones, laptops, and personal digital assistants (PDAs). With resource pooling, the provider's computing resources are pooled to serve multiple consumers using a multi-tenant model with different physical and virtual resources dynamically assigned and reassigned according to demand. There is a sense of location independence in that the consumer generally has no control or knowledge over the exact location of the provided resources but may be able to specify location at a higher level of abstraction. The higher level of abstraction may be, for example, a country, state, or datacenter.

Rapid elasticity involves capabilities that can be rapidly and elastically provisioned, in some cases automatically, to quickly scale out and rapidly release to quickly scale in. To the consumer, the capabilities available for provisioning often appear to be unlimited and can be purchased in any quantity at any time.

With measured service, cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models include software as a service (SaaS), platform as a service (PaaS), and infrastructure as a service (IaaS). With software as a service (SaaS), a capability is provided to the consumer to use the provider's applications running on a cloud infrastructure. The applications are accessible from various client devices through a thin client interface, such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a service (PaaS) is a capability provided to the consumer to deploy onto the cloud infrastructure consumer-created or acquired applications created using programming languages and tools supported by the provider. The consumer does not manage or control the underlying cloud infrastructure including networks, servers, operating systems, or storage. Instead, the consumer has control over the deployed applications and possibly application hosting environment configurations.

Infrastructure as a service (IaaS) is a capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components. These network components include, for example, host firewalls.

Deployment models include, for example, a private cloud, a community cloud, a public cloud, and a hybrid cloud. A private cloud has a cloud infrastructure that is operated solely for an organization. This type of cloud may be managed by the organization or a third party and may exist on-premises or off-premises.

A community cloud is the cloud infrastructure that is shared by several organizations and supports a specific community that has shared concerns. These concerns include, for example, mission, security requirements, policy, and compliance considerations. A community cloud may be managed by the organizations or a third party. This type of cloud may exist on-premises or off-premises.

A public cloud is the cloud infrastructure that is made available to the general public or a large industry group and is owned by an organization selling cloud services.

A hybrid cloud is the cloud infrastructure that is a composition of two or more clouds. For example, without limitation, a hybrid cloud may be a combination of two or more of a private cloud, a community cloud, and/or a public cloud. A hybrid cloud includes clouds that remain unique entities but are bound together by standardized or proprietary technology that enables data and application portability. The data and application portability includes, for example, cloud bursting for load-balancing between clouds that form the hybrid cloud.

A cloud computing environment is service oriented with a focus on statelessness, low coupling, modularity, and semantic interoperability. At the heart of cloud computing is an infrastructure comprising a network of interconnected nodes.

The computer program instructions may also be loaded onto a computer, other programmable data processing apparatus, or other devices to cause a series of operational steps to be performed on the computer, other programmable apparatus, or other devices to produce a computer-implemented process such that the instructions which run on the computer or other programmable apparatus provide processes for implementing the functions/acts specified in the flowchart and/or block diagram block or blocks.

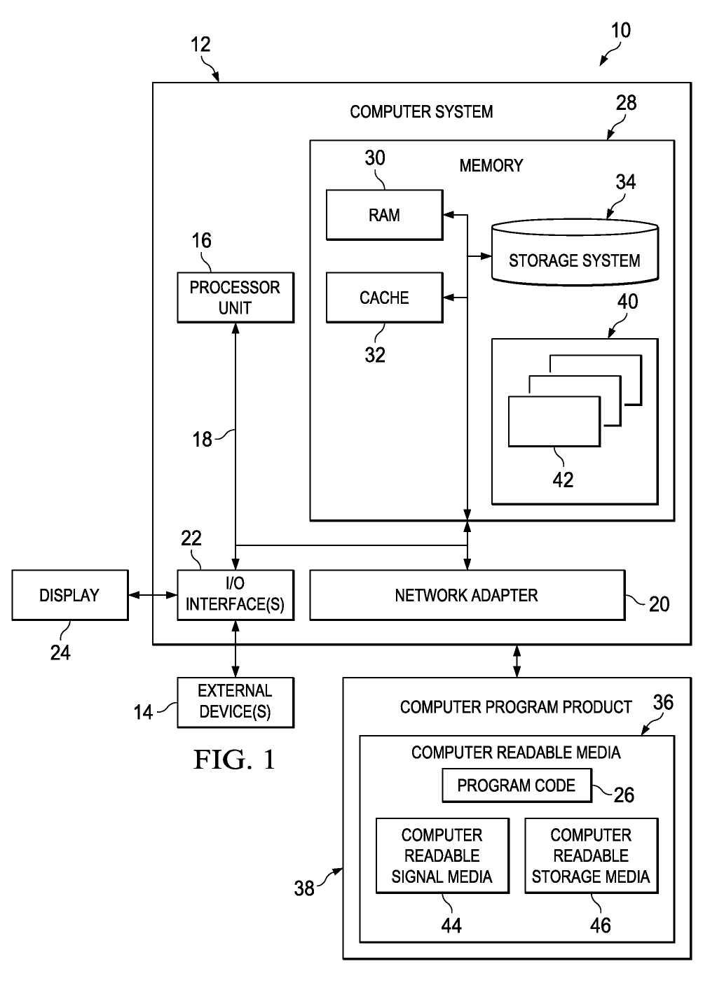

With reference now to FIG. 1, a block diagram of an example of a cloud computing node is depicted in accordance with an illustrative embodiment. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is computer system 12, which is operational with numerous other general-purpose or special-purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program modules, being run by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in cloud computing node 10 is shown in the form of a general-purpose computing device. The components of computer system 12 may include, but are not limited to, one or more processors or processor unit 16, memory 28, and bus 18 that couples various system components, including memory 28, to processor unit 16.

Processor unit 16 processes instructions for software that may be loaded into memory 28. Processor unit 16 may be a number of processors, a multi-processor core, or some other type of processor, depending on the particular implementation. “A number”, as used herein with reference to an item, means one or more items. Further, processor unit 16 may be implemented using a number of heterogeneous processor systems in which a main processor is present with secondary processors on a single chip. As another illustrative example, processor unit 16 may be a symmetric multi-processor system containing multiple processors of the same type.

Bus 18 represents one or more of any of several types of bus structures, including a memory bus or memory controller, a peripheral bus, an accelerated graphics port, and a processor or local bus using any of a variety of bus architectures. By way of example and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

Computer system 12 typically includes a variety of computer system readable media. Such media may be any available media that is accessible by computer system 12, and it includes both volatile and non-volatile media, and removable and non-removable media.

Memory 28 can include computer system readable media in the form of volatile memory, such as random access memory (RAM) 30 and/or cache 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk, such as a CD-ROM, DVD-ROM, or other optical media can be provided. In such instances, each can be connected to bus 18 by one or more data media interfaces. As will be further depicted and described below, memory 28 may include at least one program product having a set of program modules that are configured to carry out the functions of embodiments of the invention. As used herein, “a set”, when referring to items, means one or more items.

Program/utility 40, having a set of program modules 42, may be stored in memory 28 by way of example, and not limitation, as well as an operating system, one or more application programs, other program modules, and program data. Each of the operating systems, one or more application programs, other program modules, program data, or some combination thereof may include an implementation of a networking environment. Program modules 42 generally carry out the functions and/or methodologies of embodiments of the invention as described herein.

Computer system 12 may also communicate with one or more external devices 14, such as a keyboard, a pointing device, display 24, etc.; one or more devices that enable a user to interact with computer system 12; and/or any devices (e.g., network card, modem, etc.) that enable computer system 12 to communicate with one or more other computing devices. Such communication can occur via I/O interface(s) 22. Still yet, computer system 12 can communicate with one or more networks, such as a local area network (LAN), a general wide area network (WAN), and/or a public network (e.g., the Internet) via network adapter 20. As depicted, network adapter 20 communicates with the other components of computer system 12 via bus 18. It should be understood that, although not shown, other hardware and/or software components could be used in conjunction with computer system 12. Examples include, but are not limited to, microcode, device drivers, redundant processor units, external disk drive arrays, RAID systems, tape drives, data archival storage systems, etc.

Instructions for the operating system, applications, and/or programs may be located in storage devices in memory 28. In these illustrative examples, the instructions are in a functional form on storage system 34. These instructions may be loaded into random access memory 30 for processing by processor unit 16.

These instructions are referred to as program code, computer usable program code, or computer readable program code that may be read and processed by a processor in processor unit 16. The program code in the different embodiments may be embodied on different physical or computer readable storage media, such as random access memory 30 or storage system 34.

Program code 26 is located in a functional form on computer readable media 36 that is selectively removable and may be loaded onto or transferred to computer system 12 for processing by processor unit 16. Program code 26 and computer readable media 36 form computer program product 38 in these examples. In one example, computer readable media 36 may be computer readable storage media 46 or computer readable signal media 44. Computer readable storage media 46 may include, for example, an optical or magnetic disk that is inserted or placed into a drive or other device that is part of a persistent storage transfer onto a storage device, such as a hard drive, that is part of the persistent storage. Computer readable storage media 46 also may take the form of a persistent storage, such as a hard drive, a thumb drive, or a flash memory, that is connected to computer system 12. In some instances, computer readable storage media 46 may not be removable from computer system 12. In these examples, computer readable storage media 46 is a physical or tangible storage device used to store program code 26 rather than a medium that propagates or transmits program code 26. Computer readable storage media 46 is also referred to as a computer readable tangible storage device or a computer readable physical storage device. In other words, computer readable storage media 46 is a media that can be touched by a person.

Alternatively, program code 26 may be transferred to computer system 12 using computer readable signal media 44. Computer readable signal media 44 may be, for example, a propagated data signal containing program code 26. For example, computer readable signal media 44 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 26 may be downloaded over a network to a persistent storage in computer system 12 from another device or data processing system through computer readable signal media 44 for use within computer system 12. For instance, program code stored in a computer readable storage medium in a server data processing system may be downloaded over a network from the server to computer system 12. The data processing system providing program code 26 may be a server computer, a client computer, or some other device capable of storing and transmitting program code 26.

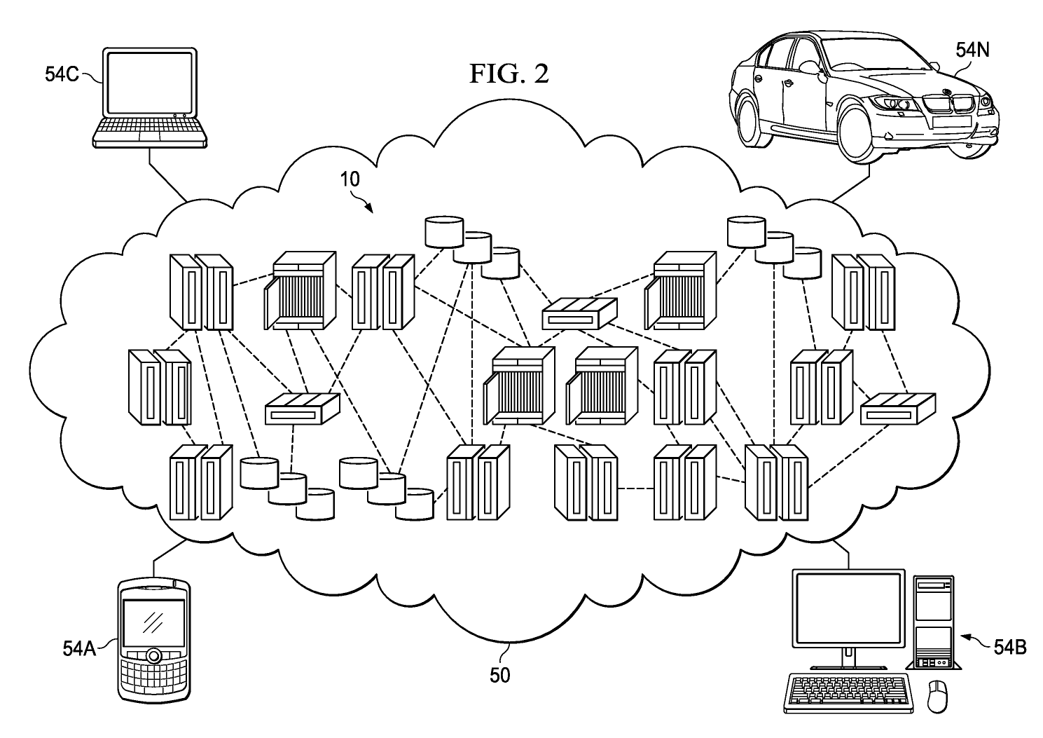

Referring now to FIG. 2, an illustration of a cloud computing environment is depicted in accordance with an illustrative embodiment. As illustrated, cloud computing environment 50 comprises one or more cloud computing nodes, such as cloud computing node 10 in FIG. 1. One or more cloud computing nodes may communicate with local computing devices used by cloud consumers, such as, for example, without limitation, personal digital assistant (PDA) or cellular telephone 54A, desktop computer 54B, laptop computer 54C, and/or automobile computer system 54N. Cloud computing node 10 may communicate with other cloud computing nodes. They may be grouped (not shown) physically or virtually, in one or more networks, such as Private, Community, Public, or Hybrid clouds, as described hereinabove, or a combination thereof. This allows cloud computing environment 50 to offer infrastructure, platforms, and/or software as services for which a cloud consumer does not need to maintain resources on a local computing device.

It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser). Program code located on one of cloud computing node 10 may be stored on a computer recordable storage medium in one of cloud computing node 10 and downloaded to a computing device within computing devices 54A-N over a network for use in these computing devices. For example, a server computer in cloud computing node 10 may store program code on a computer readable storage medium on the server computer. The server computer may download the program code to a client computer in computing devices 54A-N for use on the client computer.

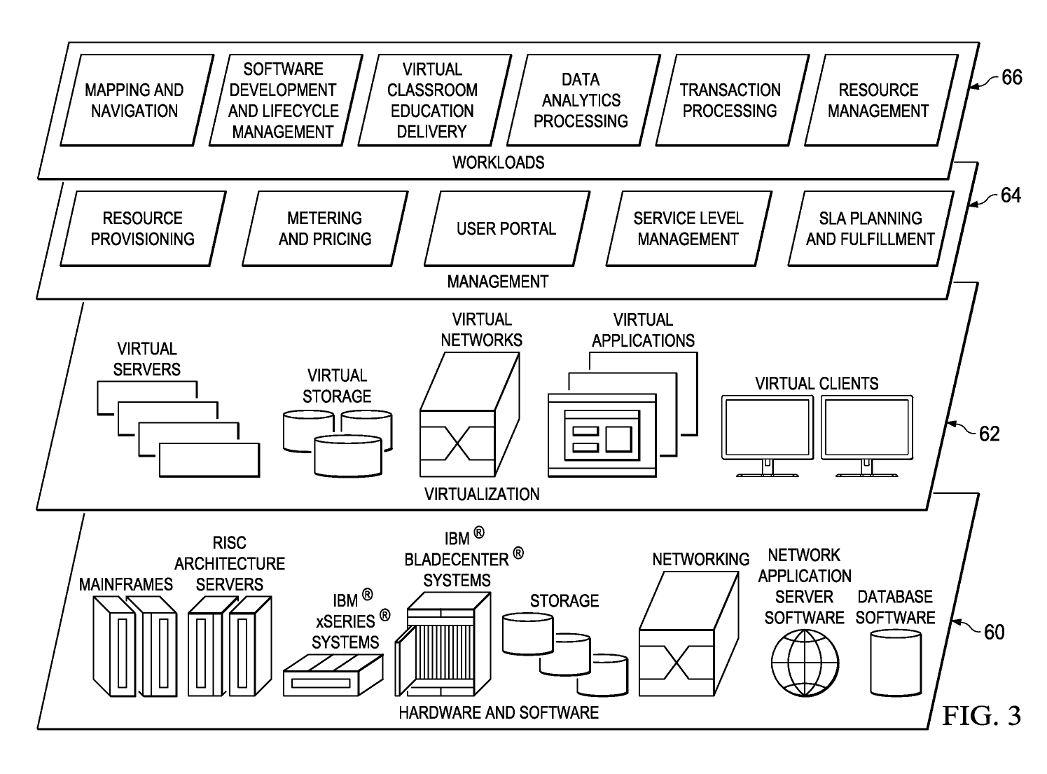

With reference now to FIG. 3, an illustration of model layers is depicted in accordance with an illustrative embodiment. The model layers are a set of functional abstraction layers provided by a cloud computing environment, such as cloud computing environment 50 in FIG. 2. It should be understood in advance that the components, layers, and functions shown in FIG. 3 are intended to be illustrative only and are embodiments of the invention that are not limited thereto. As depicted, the following layers and corresponding functions are provided:

Hardware and software layer 60 includes hardware and software components. Examples of hardware components include mainframes, for example, IBM® zSeries® systems; RISC (Reduced Instruction Set Computer) architecture based servers, for example, IBM pSeries® systems, IBM xSeries® systems, and IBM BladeCenter® systems; storage devices; networks; and networking components. Examples of software components include network application server software, for example, IBM WebSphere® application server software; and database software, for example, IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service level agreement (SLA) planning and fulfillment provide pre-arrangement for and procurement of cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation, software development and lifecycle management, virtual classroom education delivery, data analytics processing, transaction processing, and resource management. With respect to resource management, one or more of the illustrative embodiments may be implemented to provide resource management functionality in workloads layer 66 to manage the request for access to resources by different users.

The different illustrative embodiments recognize and take into account a number of different considerations. For example, the different illustrative embodiments recognize and take into account that with respect to some types of requests, existing techniques are present for handling those types of requests. For example, techniques are currently present for managing requests made during a denial-of-service attack.

The different illustrative embodiments recognize and take into account that the currently-used techniques may not be as useful for requests sent by users who are authorized to request access to resources. The different illustrative embodiments recognize and take into account that the users that are authorized to access resources may use more of the resources that are desired.

For example, a user may have an account to use a resource, such as a database. The user may make queries to the database from several different computers or devices. These programs may run on these computers or devices that constantly make requests for information from the database. This type of use of a resource may be undesirable. The different illustrative embodiments recognize and take into account that this type of use may be more than the use contemplated in providing the user access to the database.

The different illustrative embodiments recognize and take into account that preventing overuse of resources by individual users may be desirable. This type of resource use is in contrast to attacks which may be generated by programs to intentionally generate attacks.

In other words, the different illustrative embodiments recognize and take into account that it would be desirable to prevent overuse or abuse of resources by legitimate users. For example, many services contemplate that users will access these resources in person, but not through the use of programs running on one or more computers that may run for hours or days at a time accessing the resources.

Thus, the different illustrative embodiments provide a method and apparatus for managing resources. In response to a request for a set of resources from a user, a token is added to a response generated by the server application. The requests from the user are monitored in which the token identifies the user. A pattern of use may be identified for the user. A determination may then be made as to whether an overuse of a set of resources has occurred based on the pattern of use and a policy.

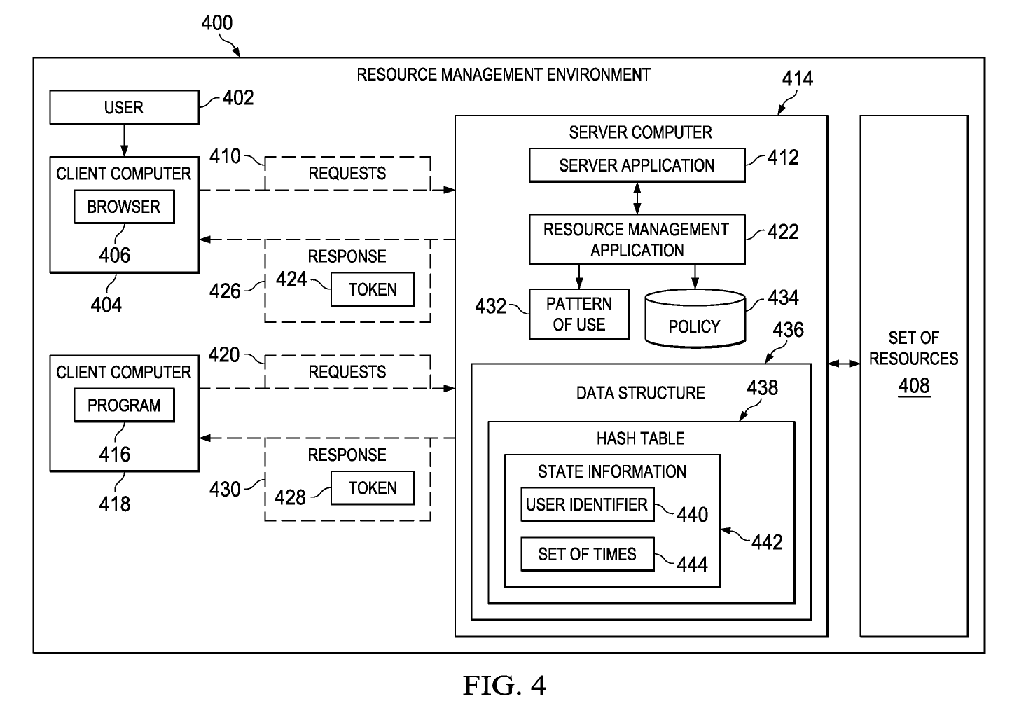

With reference now to FIG. 4, an illustration of a resource management environment is depicted in accordance with an illustrative embodiment. Resource management environment 400 is an example of a resource management environment. Resource management environment 400 may be used to provide resource management functionality in workloads layer 66 in FIG. 3.

As illustrated, user 402 may operate client computer 404. In particular, user 402 may use browser 406 to access set of resources 408. In these illustrative examples, “a set”, as used with reference to items, means one or more items. For example, “a set of resources” is one or more resources. The resources that may be accessed by user 402 may be any resources that may be made available to user 402. In these illustrative examples, a resource in set of resources 408 may include at least one of a database, an online email system, a calendaring system, an online retail store, a wiki, a spreadsheet program, an image editing application, a presentation application, an operating system, a programming environment, and/or other suitable types of resources.

As used herein, the phrase at “least one of”, when used with a list of items, means that different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C. In other examples, “at least one of” may be, for example, without limitation, two of item A, one of item B. and 10 of item C; and other suitable combinations.

Access to set of resources 408 may occur by client computer 404 generating requests 410 and sending requests 410 to server application 412 on server computer 414. Server application 412 processes requests 410 to access set of resources 408. In these illustrative examples, user 402 is an authorized user of set of resources 408. User 402 may have an account through which user 402 accesses set of resources 408.

In these illustrative examples, user 402 also may have program 416 at client computer 418. Program 416 also may generate requests 420, which are sent to server application 412 running on server computer 414. Requests 420 also may be for access to set of resources 408. In this manner, user 402 may generate both requests 410 and requests 420 from different locations at substantially the same time and/or at different times. This type of access may result in more access occurring with respect to set of resources 408 than desired for user 402.

In these illustrative examples, resource management application 422 runs on server computer 414. Resource management application 422 adds token 424 to response 426 generated by server application 412 in processing a request in requests 410 for access to set of resources 408. After token 424 is returned in response 426, token 424 is used in requests 410. Token 424 identifies user 402 in these illustrative examples.

Further, after token 424 has been returned in response 426, resource management application 422 may require token 424 to be present in future requests in requests 410. For example, if token 424 is not included in other requests, those requests are not processed. Resource management application 422 may reject or return an error message or simply discard the request when token 424 is not present in a subsequent request in requests 410.

When requests 410 including token 424 are present, resource management application 422 may then identify pattern of use 432 for user 402 through monitoring requests 420 received by server application 412. The identification of user 402 is made possible in these illustrative examples through the inclusion of token 424 or a copy of token 424 in requests 410 that are made after token 424 was sent to browser 406 in response 426.

In a similar fashion, resource management application 422 adds token 428 in response 430 generated by server application 412. Response 430 is generated by server application 412 processing a request in requests 420 for access to set of resources 408. After token 428 is returned in response 430, token 428 may be included in requests 420 made by program 416. Token 428 also identifies user 402 in these illustrative examples. Resource management application 422 also may use token 428 in requests 420 in determining whether pattern of use 432 is an overuse of set of resources 408. In other words, pattern of use 432 may be identified by resource management application 422 based on both the identification of token 424 in requests 410 and token 428 in requests 420. In this illustrative example, token 424 identifies user 402.

Request 420 may indicate a portion of the resources being used with other resources being used that may be desirable to track in pattern of use 432. For example, in addition to the application, network bandwidth, storage, processor resources, and other types of resources are often used when a user uses an application in set of resources 408. These resources also may be considered part of set of resources 408 and may be tracked as part of pattern of use 432 in addition to the use of an application in set of resources 408.

Resource management application 422 determines whether overuse of set of resources 408 has occurred based on pattern of use 432 and policy 434. Policy 434 is a number of rules. In these illustrative examples, policy 434 defines when a request for access to set of resources 408 results in an overuse of set of resources 408 for different users.

For example, policy 434 may include one or more rules that identify patterns that may indicate overuse. Further, overuse may identify patterns that indicate normal use by user 402. In still other illustrative examples, these rules may identify processes to determine whether a particular pattern represents overuse. For example, human interaction with an application follows a particular pattern in terms of responding time. For example, user 402 interacts with browser 406 in a manner such that the amount of time between requests for different actions may have a particular pattern.

Policy 434 may identify these patterns or rules for identifying the patterns. For example, policy 434 may include at least one of a minimum time between consecutive interaction with the resource, a number of interactions within a selected period of time, and other suitable types of parameters. The particular patterns or parameters selected may depend on the particular implementation and resource. For example, the time interval may be different for different applications, different groups of users, at different times, and for other circumstances and/or events.

If resource management application 422 determines that an overuse of set of resources 408 has occurred, resource management application 422 may change the access provided to user 402 to set of resources 408. For example, resource management application 422 may increase a response time needed to process requests 410. In another example, resource management application 422 may deny access to set of resources 408. This denial of access may be for a short period of time. In still other illustrative examples, resource management application 422 may suspend the account for user 402 for some period of time based on an overuse of set of resources 408. These responses and other actions may be performed based on policy 434 in these illustrative examples.

In these illustrative examples, resources management application 422 uses data structure 436 to track requests from user 402 and other users. Data structure 436 takes the form of hash table 438.

In response to a request in requests 410 by user 402, resource management application 422 generates an entry in hash table 438. Hash table 438 is a data structure that uses a hash function to map different values to associated values. For example, the value may be user identifier 440 for user 402 which maps to other information. User identifier 440 is an index used to access state information 442. User identifier 440 may have a value for user 402 in these illustrative examples.

State information 442 is information that tracks requests 410 made by user 402. In these illustrative examples, state information 442 takes the form of set of times 444. For example, set of times 444 may include a last time that set of resources 408 was accessed by user 402. Set of times 444 may take the form of timestamps.

As a result, a last time from set of times 444 may be compared to a current time to identify a difference between the current time and the last time. This difference may be used to determine whether an overuse in set of resources 408 has occurred.

For example, user 402 may generate requests 410 at a particular rate for a particular resource in set of resources 408. When a program, such as program 416, is used, then the access may be faster than that normally made by user 402. As a result, if the requests are being generated too quickly, then overuse may be present. In these illustrative examples, the last time indicates a time that a last request to set of resources 408 was made by the user.

Of course, other types of measurements can be made to identify patterns of use that may be more than desired. For example, measurements may be made of server response time. Additionally, if the user request takes a significant amount of the server time to complete when, in regular use, the server may take much less time to complete the request, and a pattern of this occurrence may be considered to be a pattern of use that is undesired. If some of the requests use more server time to respond than desired, these requests may be marked as overuse. The types of measurements made in identifying a pattern may include use of the server side resources. These resources may include, for example, server CPU time, number of files accessed, amount of hard disk space used, energy usage, and other suitable resources.

In another illustrative example, the heat, noise, or both, produced when certain requests are processed by server side resources, may be measured to identify a pattern of use. In still another example, the sensitivity of the information needed to process particular requests may be measured to identify a pattern of use.

In this manner, requests from different computers or devices that may generate a request for access to set of resources 408 may be monitored by resource management application 422. In some instances, the use of client computer 404 and client computer 418 to generate requests 410 and requests 420 may not be considered an overuse, depending on policy 434. In this manner, user 402 may access set of resources 408. This access, however, is in a manner that may be managed to prevent overuse of set of resources 408 through the use of resource management application 422 in these illustrative examples.

The illustration of resource management environment 400 in FIG. 4 is not meant to imply physical or architectural limitations for the manner in which an illustrative embodiment may be implemented. Other components in addition to and/or in place of the ones illustrated may be used. Some components may be unnecessary. Also, the blocks are presented to illustrate some functional components. One or more of these blocks may be combined and/or divided into different blocks when implemented in an illustrative embodiment.

For example, in some illustrative examples, resource management application 422 may be located on a different computer from server application 412. In other words, resource management application 422 may be located on another server computer other than server computer 414. In still other illustrative examples, other users may make requests for set of resources 408.

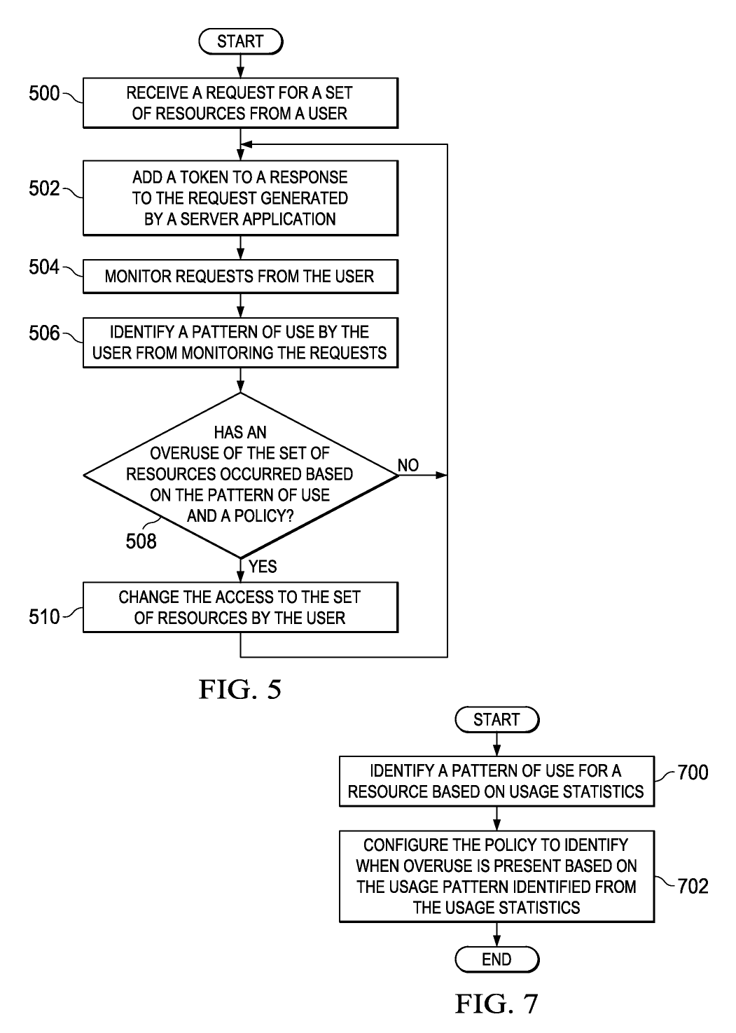

With reference now to FIG. 5, an illustration of a flowchart of a process for managing resources is depicted in accordance with an illustrative embodiment. The process illustrated in FIG. 5 may be implemented in resource management application 422 in FIG. 4. These different steps may be implemented as program code and stored in a computer readable storage medium.

The process begins by receiving a request for a set of resources from a user (step 500). The process then adds a token to a response to the request generated by a server application (step 502).

The process then monitors requests from the user (step 504). The requests received from the user after the token is added to the response will include the token in these illustrative examples. A pattern of use by the user is identified from monitoring the requests (step 506). A determination is then made as to whether overuse of the set of resources has occurred based on the pattern of use and a policy (step 508).

If an overuse of the set of resources has not occurred, the process then returns to step 502. Otherwise, the process changes the access to the set of resources by the user (step 510), with the process then returning to step 502 as described above. The change in the access to the set of resources may take a number of different forms. For example, an increased response time may be set to process requests for the set of resources, access may be denied to the set of resources, and in some cases, the account of the user may be suspended or cancelled, depending on the application of the policy to the requests.

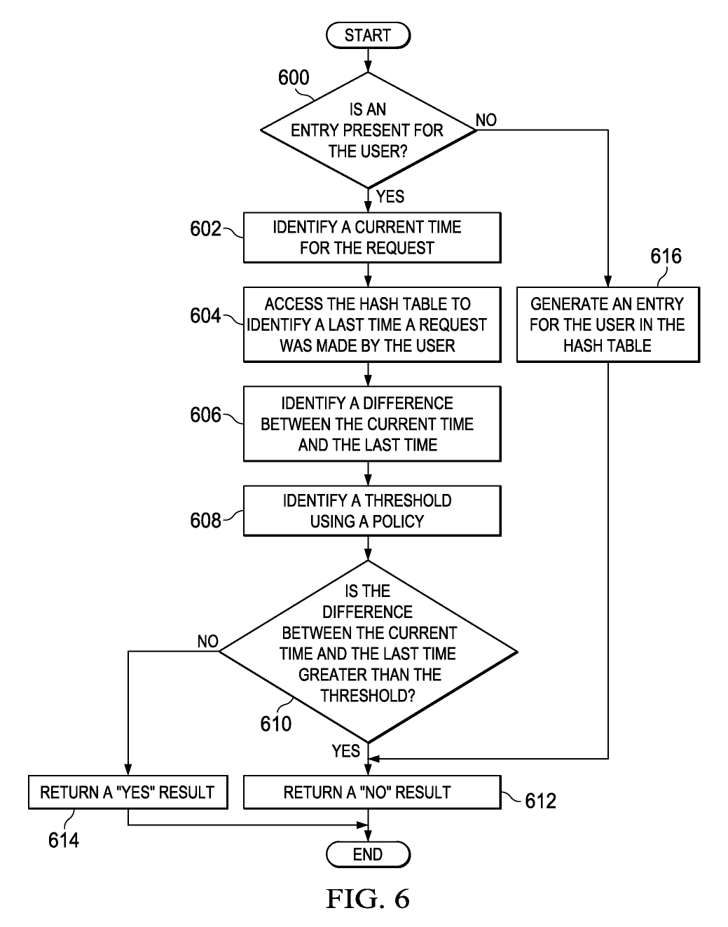

With reference now to FIG. 6, an illustration of a flowchart of a process for determining whether overuse of a set of resources has occurred based on a pattern of use is depicted in accordance with an illustrative embodiment. This process is an example of one implementation for step 508 in FIG. 5.

The process begins by determining whether an entry is present for the user (step 600). This determination may be made by determining whether the user identifier for the user obtained from the token is present in the hash table. If an entry is present, the process identifies a current time for the request (step 602). The process accesses the hash table to identify a last time a request was made by the user (step 604).

A difference between the current time and last time is identified (step 606). A threshold is identified using a policy (step 608). In step 608, the policy may include a rule identifying a threshold to a time interval that is considered overused. For example, the policy may set a threshold for the difference between the current time and the last time.

The process then determines whether the difference between the current time and the last time is greater than the threshold (step 610). If the difference is greater than the threshold, then overuse is not considered to be present and the process returns a “no” result (step 612), with the process terminating thereafter. If the difference is less than the threshold, then a “yes” result is returned (step 614), with the process terminating thereafter.

With reference again to step 600, if an entry is not present for the user in the hash table, the process generates an entry for the user in the hash table (step 616), with the process then proceeding to step 612 as described above.

With reference now to FIG. 7, an illustration of a flowchart of a process for managing a policy is depicted in accordance with an illustrative embodiment. The process illustrated in FIG. 7 may be implemented by resource management application 422 to manage policy 434 in FIG. 4. The process identifies a pattern of use for a resource based on usage statistics (step 700). These usage statistics may be, for example, an average pattern of use for all users. In some cases, the pattern may be identified for different user groups. In still other illustrative examples, the pattern of use may be for different parts of the resource or all of the resource.

The process then configures the policy to identify when overuse is present based on the usage pattern identified from the usage statistics (step 702), with the process terminating thereafter. The rule generated based on the pattern may be in the form of time intervals. The time intervals may be some period of time that is considered to be a threshold between overuse and acceptable use of a resource. In still other illustrative examples, the rules may include a pattern of request types that are made within periods of time, or the policy may include a rule that identifies the time interval based on the time of day, day of the week, month, or other times when access is made. Of course, any type of rule may be generated, depending on the particular implementation and resource being managed.

The flowcharts and block diagrams in the different depicted embodiments illustrate the architecture, functionality, and operation of some possible implementations of apparatus, methods, and computer program products. In this regard, each block in the flowcharts or block diagrams may represent a module, segment, or portion of computer usable or readable program code, which comprises one or more instructions for implementing the specified function or functions. In some alternative implementations, the function or functions noted in the block may occur out of the order noted in the figures. For example, in some cases, two blocks shown in succession may be performed substantially concurrently, or the blocks may sometimes be performed in the reverse order, depending upon the functionality involved.

For example, in FIG. 6, the process identifies overuse based on a difference between time intervals. In still other illustrative examples, other types of rules may be implemented other than the one depicted in FIG. 6. For example, in other illustrative examples, a pattern of types of requests made within time intervals may be used to determine whether overuse is present. In still other illustrative examples, the number of requests within a time period made from different Internet protocol addresses may be used to determine whether overuse is present. These and other types of rules may be used, depending on the particular resource and implementation.

Thus, the different illustrative embodiments provide a method and apparatus for managing resources. In the different illustrative examples, the resources are managed to reduce overuse of resources by a particular user who is authorized to access the set of resources. In this manner, different resources, such as applications, databases, and the like, may be managed such that overuse of these types of resources may be reduced.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for managing resources, the method comprising:
responsive to a request for a set of resources by a user, adding a token to a response to the request generated by a server application;
monitoring requests from the user, wherein the token identifies the user;
identifying a pattern of use by the user; and
determining whether overuse of the set of resources has occurred based on the pattern of use and a policy.

2. The method of claim 1 further comprising:
denying access to the set of resources in response to a determination that the overuse of the set of resources has occurred.

3. The method of claim 1 further comprising:
increasing a response time to process the request for the set of resources in response to a determination that the overuse of the set of resources has occurred.

4. The method of claim 1 further comprising:
responsive to the request for the set of resources by the user, creating an entry in a hash table for the user, wherein an identification of the user and state information is stored in the entry for the user.

5. The method of claim 4, wherein the state information comprises a last time that the set of resources was accessed by the user.

6. The method of claim 4, wherein the state information comprises a last time indicating a time that a last request to access the set of resources was made for the user and wherein the determining step comprises:
identifying a difference between a current time and the last time; and
determining whether the overuse of the set of resources has occurred using the difference.

7. The method of claim 1 further comprising:
responsive to identifying the overuse in the request from the user that is greater than a threshold, suspending an account for the user.

8. The method of claim 1, wherein the request for the set of resources by the user is sent from a client computer, the set of resources are a set of cloud computing resources managed by a resource management application, the server application is a cloud computing application managed by the resource management application, and the monitoring, identifying, and determining steps are performed by the resource management application.

9. The method of claim 8, wherein the requests for the set of cloud computing resources by the user comprise a first request made by the user from a first client application at a first time and a second request made by the user from a second client application at a second time and the determining step comprises:
identifying a difference between the first time and the second time; and
determining whether the overuse of the set of resources has occurred using the difference.

10. The method claim 8, wherein the requests for the set of cloud computing resources by the user comprise a first request made by the user from a first client computer at a first time and a second request made by the user from a second client computer at a second time and the determining step comprises:
identifying a difference between the first time and the second time; and
determining whether the overuse of the set of resources has occurred using the difference.

11. A computer system comprising:
a bus;
a set of storage devices connected to the bus, wherein program code is stored on the set of storage devices; and
a processor unit configured to run the program code to add a token to a response to a request for a set of resources generated by a server application in response to the request for the set of resources by a user; monitor requests from the user, wherein the token identifies the user; identify a pattern of use by the user; and determine whether overuse of the set of resources has occurred based on the pattern of use and a policy.

12. The computer system of claim 11, wherein the processor unit is further configured to deny access to the set of resources in response to a determination that the overuse of the set of resources has occurred.

13. The computer system of claim 11, wherein the processor unit is further configured to increase a response time to process the request for the set of resources in response to a determination that the overuse of the set of resources has occurred.

14. The computer system of claim 11, wherein the processor unit is further configured to, responsive to the request for the set of resources by the user, create an entry in a hash table for the user, wherein an identification of the user and state information is stored in the entry for the user in response to the request for the set of resources.

15. The computer system of claim 14, wherein the state information comprises a last time indicating a time that a last request to access the set of resources was made for the user and wherein in being configured to determine whether the overuse of the set of resources comprises:
identifying a difference between a current time and the last time; and
determining whether the overuse of the set of resources has occurred using the difference.

16. The computer system of claim 11, wherein the processor unit is further configured to suspend an account for the user in response to identifying the overuse in the request from the user that is greater than a threshold.

17. A computer program product comprising:
a computer readable storage medium;
first program code, responsive to a request for a set of resources by a user, for adding a token to a response to the request generated by a server application;
second program code for monitoring requests from the user, wherein the token identifies the user;
third program code for identifying a pattern of use by the user; and
fourth program code for determining whether overuse of the set of resources has occurred based on the pattern of use and a policy, wherein the first program code, the second program code, the third program code, and the fourth program code are stored on the computer readable storage medium.

18. The computer program product of claim 17 further comprising:
fifth program code for denying access to the set of resources in response to a determination that the overuse of the set of resources has occurred, wherein the fifth program code is stored on the computer readable storage medium.

19. The computer program product of claim 17, wherein the computer readable storage medium is in a data processing system, and the program code is downloaded over a network from a remote data processing system to the computer readable storage medium in the data processing system.

20. The computer program product of claim 17, wherein the computer readable storage medium is a first computer readable storage medium, wherein the first computer readable storage medium is in a server data processing system, and wherein the program code is downloaded over a network to a remote data processing system for use in a second computer readable storage medium in the remote data processing system.
